(19) United States
(12) Patent Application Publication
(10) Pub. No.: US 2005/0231030 A1
(43) Pub. Date: Oct. 20, 2005

(54) Method of braking an airplane having a plurality of braked wheels

(75) Inventor: David Frank, Paris (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI

(21) Appl. No.: 11/082,776

(22) Filed: Mar. 18, 2005

(30) Foreign Application Priority Data
Apr. 19, 2004 (FR) 04 04093

(51) Int. Cl. B60T 8/18; B60T 8/86

(52) U.S. Cl. 303/126

(57) ABSTRACT

The invention relates to a method of braking an airplane having a plurality of wheels capable of being braked in controlled manner, the method comprising the step of applying braking to a first group of wheels of the airplane, and then after a time offset, applying braking to a second group of wheels of the airplane.

The invention relates to a method of braking an airplane having a plurality of braked wheels.

### BACKGROUND OF THE INVENTION

The ratio of the braking force developed by a braked wheel and the vertical load acting on the wheel is representative of the friction acting between the tire of the wheel and the runway. It is well known that the value of this ratio depends on various parameters such as the state of the runway, the degree of wear of the tire, or indeed the speed of the airplane. In addition, the value of this ratio varies during braking: prior to reaching a stabilized value, the ratio presents an initial overshoot of value that is greater than said stabilized value.

This initial overshoot is most troublesome insofar as it leads to a transient braking force of large intensity which needs to be taken into account when dimensioning the undercarriage and the structure of the airplane. This transient braking force can in particular be the determining factor when dimensioning the undercarriage in the zone where the undercarriage is attached to the main structure, and also when dimensioning the portion of the fuselage that extends between the main undercarriage carrying the braked wheels and the auxiliary undercarriage.

In order to avoid those drawbacks, proposals have been made to program the braking computer of the airplane so that it is capable of limiting the braking force developed by each braked wheel to a predetermined maximum level. In practice, that turns out to be very difficult to implement since it is very difficult to measure the braking force being developed by a given braked wheel. This limitation must therefore be lowered even further since the instantaneous performance of a brake is difficult to predict, which leads to taking safety margins that put a considerable limit on the performance of the brake.

Proposals have also been made to apply the braking force progressively, following a predetermined gradient. However the highly non-linear nature of the response of the brake makes such control extremely uncertain.

Proposals have also been made to inhibit braking on a certain number of wheels. Nevertheless, operating in that manner requires logic that is complex. In the event of one of the non-inhibited brakes failing, it is necessary to be able to detect the failure quickly and to activate one of the inhibited brakes to replace the failed brake in order to conserve a level of braking equal to the level of braking that would be developed in the absence of a failure.

Protection systems are also known for avoiding skidding, which systems act on each of the wheels to modulate the general braking setpoint as generated by the braking computer in order to ensure that the wheels do not lock. Thus, although braking is applied simultaneously on all of the wheels, if the anti-wheel-lock system is in operation, it can happen that the transient force on some of the wheels on the undercarriage acts at different moments in time compared with the transient force from other wheels of the undercarriage, thereby diminishing the overall transient braking force to which the undercarriage is subjected. Nevertheless, this reduction is transient and presents a highly random nature, which means that it cannot be taken into account when dimensioning the undercarriage.

The technological background of the invention is illustrated in particular by the following documents: GB 2 311 108-A; U.S. Pat. No. 5,417,477; U.S. Pat. No. 5,217,282; U.S. Pat. No. 5,172,960; U.S. 2004/065776-A1; and also EP 0 329 373-A.

### OBJECT OF THE INVENTION

An object of the invention is to provide a method of braking an airplane having a plurality of wheels that can be braked in controlled manner, and making it possible reliably to reduce the maximum braking force while avoiding the drawbacks of the prior art.

### BRIEF SUMMARY OF THE INVENTION

The invention provides a method of braking an airplane having a plurality of wheels capable of being braked in controlled manner, which method comprises the step of applying braking to a first group of wheels of the airplane, and then after a time offset, applying braking to a second group of wheels of the airplane.

The time offset as introduced in this way between braking commands reliably guarantees that the transient force generated by the braking of the second group of braked wheels will not occur simultaneously with the transient force generated by the braking of the first group of braked wheels, thereby decreasing the transient braking force to which the airplane is subjected.

This serves to reduce the forces seen by the airplane while using a method that is very simple to implement, since it requires no more than a time delay and does not require any complex logic.

The method of the invention also remains entirely compatible with implementing systems for protecting against wheel-lock.

In a particular implementation of the method of the invention as applied to an airplane having a plurality of main undercarriages carrying braked wheels, the first group of wheels is constituted by all of the wheels carried by a first group of undercarriages, and the second group of wheels is constituted by all of the wheels carried by a second group of undercarriages.

In which case, preferably, when the airplane has wing main undercarriages and at least one fuselage main undercarriage, one of the groups of undercarriages is constituted by the wing undercarriages, while the other group of undercarriages is constituted by the fuselage undercarriage(s).

In another implementation of the method of the invention, one of the groups is constituted by wheels carried by distinct undercarriages.

In which case, preferably, when the braked wheels are carried as diabolos at the ends of two main undercarriages, with each diabolo comprising an inner wheel and an outer wheel, one of the groups of wheels is constituted by the outer wheels of both undercarriages, and the other group of wheels is constituted by the inner wheels of both undercarriages.

In another implementation of the method of the invention applied to an airplane having an undercarriage including a bogie hinged thereto and carrying one pair of front wheels and one pair of rear wheels, the front pair of wheels and the rear pair of wheels form portions of two distinct groups of wheels.

Finally, the time offset is advantageously shorter than one second.

### BRIEF DESCRIPTION OF THE DRAWINGS

The invention will be better understood in the light of the following description given with reference to the figures of the accompanying drawings, in which:

FIG. 1 is a diagrammatic front view of an airplane having two wing main undercarriages each carrying a pair of braked wheels in a diabolo configuration;

FIG. 2 is a graph showing how braking forces generated by each of the groups of braked wheels of the airplane shown in FIG. 1 varies over time;

FIG. 3 is a diagrammatic plan view of an airplane having two wing main undercarriages and a fuselage main undercarriage; and

FIG. 4 is a diagrammatic and fragmentary side view of an airplane having wing main undercarriages fitted with bogies, and shown while landing.

### DETAILED DESCRIPTION OF THE INVENTION

With reference to FIG. 1, the method of the invention is applied to an airplane A1 (e.g. of the Airbus A320 or Boeing 737 type) having two main undercarriages 1 each carrying an inner braked wheel 2 and an outer braked wheel 3 in a diabolo configuration.

The airplane is also fitted with an auxiliary undercarriage 4 fitted with wheels that are not braked.

During braking on landing, the method of the invention consists in applying the brakes in a first group of braked wheels, specifically the group constituted by the inner wheel 2 of the two main undercarriages 1, and then after a time offset, in applying the brakes to a second group of braked wheels, specifically the group constituted by the outer wheel 3 of the two main undercarriages 1.

The braking as performed in this way remains symmetrical, and therefore does not deflect the path followed by the airplane.

It should be observed that runways are generally cambered, sloping down from the axis of the runway to its side edges at about 3%. One of the effects of this slope is to increase the vertical loading on the inner wheels 1 relative to the vertical loading on the outer wheels 3. The braking capacity of the inner wheels 2 is thus slightly greater than that of the outer wheels 3. That is why the inner wheels 2 are braked initially, in preference to the outer wheels 3.

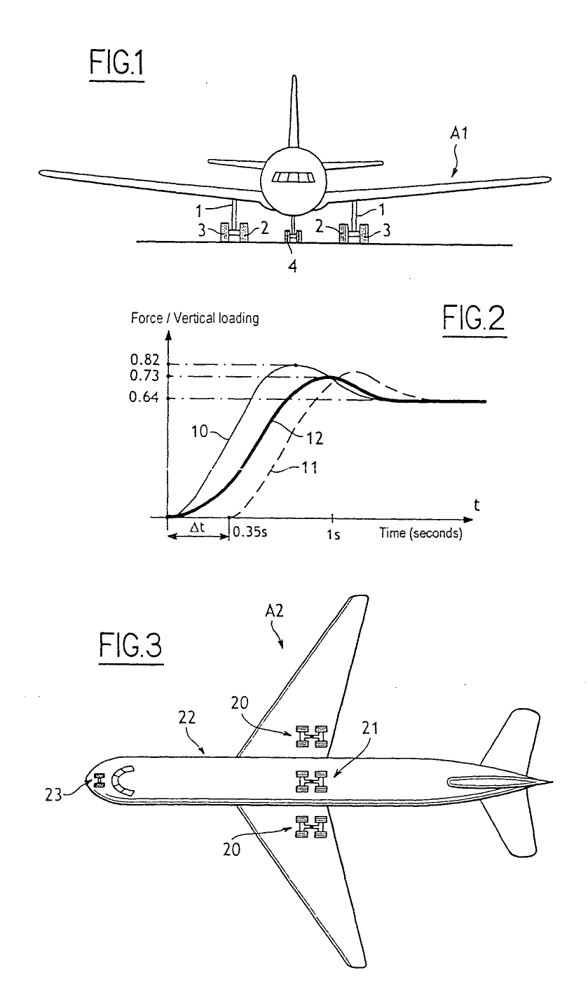

In FIG. 2, curve 10 (continuous line) shows how the sum of the braking forces generated by the inner wheels 2 varies over time compared with the sum of the vertical loading on said inner wheels 2.

As can be seen in FIG. 2, the curve 10 presents a transient overshoot up to a value of 0.82, before falling back and tending towards a stabilized value of 0.64.

Curve 11 (in dashed lines) is a curve similar to curve 10, but relating to the group of outer wheels 3. Curve 11 has the same shape as curve 10, but is offset in time by an offset Δt in accordance with the invention. In this case, the offset is about 0.35 seconds (s).

Curve 12 (heavy line) shows the resultant of the braking forces from all of the braked wheels relative to the resultant of the vertical loading on said braked wheels.

It can be seen that curve 12 presents initial overshoot, but that is it smaller than the overshoot in curves 10 and 11. The overshoot of curve 12 in this case reaches a value of 0.73, i.e. it is 11% lower than the value the same overshoot would have reached if the brakes had been applied to all of the wheels simultaneously.

In the absence of any rational analysis or testing, standards for certifying commercial airplanes (JAR25, AR25) require the maximum value of the braking force on a braked wheel to be assumed to be equal to not less than 0.8 times the vertical loading on said wheel. It can be seen that the method of the invention makes it possible to achieve a saving of about 9% relative to that arbitrary force.

It might be thought that applying braking by a fraction of the wheels after a time delay would increase the braking distance needed by the airplane. For an airplane fitted with a hydraulic braking system, that assumption needs to be taken in perspective. In the implementation described above, the brakes are applied in halves. On each application, the volume of the cylinders to be filled thus corresponds to half the total volume. For identical hydraulic fluid delivery rate, response time is therefore substantially halved, so the braking force is applied more quickly. This reduction in response time compensates to a very large extent for the time offset introduced by the fact of implementing the method of the invention. The overall braking distance is therefore affected only very little.

Certain airplanes (e.g. of the Boeing 747, Airbus A340-600 or Airbus A380 types) have two wing main undercarriages and one or more fuselage main undercarriages. The airplane A1 shown in FIG. 3 thus have two wing main undercarriages 20, and a fuselage main undercarriage 21, each of the undercarriages in this case having four braked wheels. The airplane A2 also has an auxiliary undercarriage 23.

Implementing the method of the invention in this case consists in applying the brakes of the wheels of the wing main undercarriages 20 forming a first undercarriage group, and after a time offset, in applying the brakes of the wheels of the fuselage main undercarriage 21 which forms a second undercarriage group.

Braking as implemented in this way is symmetrical, thereby avoiding any deflection of the path followed by the airplane.

The graph of FIG. 2 can also be used to illustrate the effects of the method of the invention. In this case, curve 10 shows the braking force from the group constituted by the wing main undercarriages 20 (relative to the sum of the vertical loading on the wheels concerned), and curve 11 shows the braking force of the group constituted by the fuselage main undercarriage 21 (relative to the sum of the vertical loading on the wheels concerned). The total braking force is represented by curve 12.

In this case also, there is a reduction in the transient braking force. The bending moment applied to the portion of the fuselage 22 extending between the fuselage main undercarriage 21 and the auxiliary undercarriage 23 during braking is proportional (ignoring inertial effects) to the braking force shown by curve 12. This bending moment determines dimensioning in certain airplanes having a very long fuselage, such as the Airbus A340-600, for example. Reducing braking force in accordance with the invention thus makes it possible to lighten the structure of the airplane and also of the undercarriage itself.

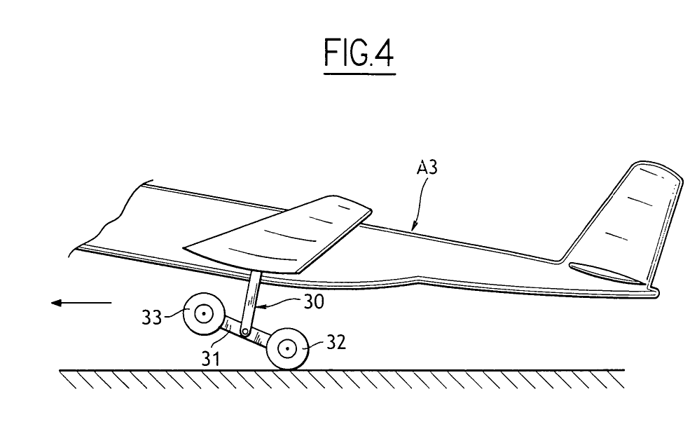

In a particular implementation applied to an airplane A3 shown in FIG. 4 having wing main undercarriages 30 each including a tilting bogie 31 carrying pairs of wheels in diabolo configuration, i.e. a front pair of wheels 32 and a rear pair of wheels 33, braking is applied initially to the rear wheels 32, and then after a time offset, braking is applied to the front wheels 33.

Thus, braking is applied initially to the wheels that strike the runway first, specifically in this case the rear wheels 32, as soon as they come into contact with the runway, thus making it possible to begin braking even though some of the wheels carried by the bogie 31 are still not in contact with the ground.

Then, after a time offset, braking is applied to the front wheels 33.

In this implementation of the method of the invention, one of the groups of braked wheels is constituted by the rear wheels 32 of both wing undercarriages 30, while the other group of braked wheels is constituted by the front wheels of the two wing undercarriages 30. The braking performed in this way is symmetrical, thus ensuring that the path followed by the airplane is not deflected.

In practice, under normal landing conditions, the time offset, which in this case is about half a second, is much less than the time needed for the front wheels 33 to touch the ground due to tilting of the bogie 31. Thus, implementing the method of the invention has no influence on the operation of the airplane under normal landing situations. Nevertheless, in abnormal landing situations, when the trim of the airplane is such that the rear and front wheels strike the runway simultaneously, the method of the invention is again advantageous in that it prevents the transient braking forces from the front wheels and the rear wheels being superposed.

It should be observed that although in normal landing situations the brakes are applied before the front wheels 33 have touched the ground, the anti-wheel-lock protection ensures that the brakes are not, in fact, applied until the front wheels 33 have reached a certain speed of rotation.

The invention is not limited to the particular implementations described above, but on the contrary covers any variant coming within the ambit of the invention as defined by the claims.

In particular, although the braked wheels in the examples shown are organized in two groups, it is possible within the ambit of the invention to organize the braked wheels into more than two groups, with the groups of wheels as organized in this way having heir brakes applied in succession one after another. In the limit, each group could be constituted by a single braked wheel.

Although the implementations shown relate to applying the brakes to a first group of wheels and then to a second group of wheels, the way in which the groups of wheels are organized is not necessarily unchanging, but could on the contrary vary each time the brakes are applied. In particular, the groups could be swapped over so that the wheels that were in the second group during a previous braking operation become the wheels of the first group during a subsequent braking operation, and vice versa. Swapping in this way smoothes out wear and temperature (amongst other parameters) for the brakes of each wheel, and this can be done either systematically each time the brakes are applied, or else as a function of parameters such as the mean temperature reached by the brakes of a given group of wheels.

Although in some of the implementations shown it is stated that the time offset has a predetermined value, the time offset could be determined on each braking operation as a function of data such as the mass and the balance of the airplane, or the gradient with which braking force from the wheels in the first group of braked wheels rises. In general, the time offset as determined in this way will be less than one second.

The method of the invention can be implemented equally well when applying the brakes for sudden application of the brakes, as when applying the brakes for progressive application thereof. The method of the invention may also be implemented by combining a sudden application of braking on one of the groups of braked wheels and progressive application of braking on the other group of braked wheels.

1. A method of braking an airplane having a plurality of wheels capable of being braked in controlled manner, the method comprising the step of applying braking to a first group of wheels of the airplane, and then after a time offset, applying braking to a second group of wheels of the airplane.

2. A method according to claim 1, applied to an airplane having a plurality of main undercarriages carrying the braked wheels, wherein the first group of wheels is constituted by all of the wheels carried by a first group of undercarriages, and wherein the second group of wheels is constituted by all of the wheels carried by a second group of undercarriages.

3. A method according to claim 2, applied to an airplane having wing main undercarriages and at least one fuselage main undercarriage, wherein one of the groups of undercarriages is constituted by the wing undercarriages, while the other group of undercarriages is constituted by the fuselage undercarriage(s).

4. A method according to claim 1, wherein one of the groups is constituted by wheels carried by distinct undercarriages.

5. A method according to claim 4, applied to an airplane having braked wheels carried in diabolos at the ends of two main undercarriages, each diabolo comprising an inner wheel and an outer wheel, wherein one of the groups of wheels is constituted by the outer wheels of both undercarriages, and the other group of wheels is constituted by the inner wheels of both undercarriages.

6. A method according to claim 1, applied to an airplane having a main undercarriage with a bogie hinged thereto and carrying at least one front pair of wheels and at least one rear pair of wheels, wherein the front pair of wheels and the rear pair of wheels form portions of two distinct groups of wheels.

7. A method according to claim 1, wherein the time offset is less than one second.
